(19) United States
(12) Patent Application Publication
(10) Pub. No.: US 2022/0094480 A1
(43) Pub. Date: Mar. 24, 2022

(54) FEEDBACK INDICATION METHOD AND COMMUNICATIONS APPARATUS

(71) Applicant: HUAWEI TECHNOLOGIES CO., LTD., Shenzhen (CN)

(72) Inventors: Haining HUANG, Beijing (CN); Junwei WANG, Shenzhen (CN); Xingwei ZHANG, Lund (SE); Chao LI, Beijing (CN); Ronghui WEN, Beijing (CN)

(21) Appl. No.: 17/541,618

(22) Filed: Dec. 3, 2021

Related U.S. Application Data
(63) Continuation of application No. PCT/CN2020/094453, filed on Jun. 4, 2020.

(30) Foreign Application Priority Data
Jun. 4, 2019 (CN) 201910482602.8

(51) Int. Cl. H04L 1/16; H04L 1/18; H04W 72/12

(52) U.S. Cl. CPC H04L 1/1678; H04L 1/1812; H04L 1/1621; H04W 72/1242; H04W 72/1231

(57) ABSTRACT

Embodiments of this application disclose a feedback indication method and a communications apparatus, and relate to the communications field, to unify behavior of a transmitting party and a receiving party. This ensures data transmission performance as far as possible. The method includes: A transmitting node determines a first message. A first field in the first message is set to be null, and the first field is used to indicate a time-frequency resource that carries hybrid automatic repeat request HARQ information. The transmitting node sends the first message to a receiving node. The first message is used to indicate the receiving node to delay feeding back HARQ information corresponding to a first transport block TB, or the first message is used to indicate the receiving node to give up feeding back the HARQ information corresponding to the first TB. The first TB is a transport block scheduled by the first message.

### CROSS-REFERENCE TO RELATED APPLICATIONS

This application is a continuation of International Application No. PCT/CN2020/094453, filed on Jun. 4, 2020, which claims priority to Chinese Patent Application No. 201910482602.8, filed on Jun. 4, 2019. The disclosures of the aforementioned applications are hereby incorporated by reference in their entireties.

### TECHNICAL FIELD

Embodiments of this application relate to the communications field, and in particular, to a communications method and a communications apparatus.

### BACKGROUND

In a wireless communications system, a hybrid automatic repeat request (HARQ) technology is usually used between a receiving party and a transmitting party to improve data transmission reliability. Specifically, a transmitting node sends a transport block (TB) to a receiving node. If the receiving node successfully receives the TB, the receiving node feeds back a positive acknowledgement (ACK) to the transmitting node. In some embodiments, if the receiving node fails to receive the TB, the receiving node feeds back a negative acknowledgement (NACK) to the transmitting node. After receiving the NACK from the receiving node, the transmitting node may retransmit the TB to the receiving node.

In some embodiments, the transmitting node may indicate, to the receiving node by using control signaling, a resource for feeding back the ACK or the NACK. When the transmitting node does not indicate the resource for feeding back the ACK or the NACK, the transmitting party and the receiving party have inconsistent understanding on HARQ retransmission behavior, which may cause confusion in data transmission.

### SUMMARY

Embodiments of this application provide a feedback indication method and a communications apparatus, to unify behavior of a transmitting party and a receiving party. This ensures data transmission performance as far as possible.

To achieve the foregoing objective, the following technical solutions are used in the embodiments of this application.

In some embodiments (sometimes referred to as, “a first aspect”), a feedback indication method is disclosed, including: determining, by a transmitting node, a first message, where a first field in the first message is set to be null, and the first field is used to indicate a time-frequency resource that carries hybrid automatic repeat request (HARQ) information, or indicate information related to the time-frequency resource that carries the HARQ information; and sending, by the transmitting node, the first message to a receiving node, and the first message is used to indicate the receiving node to delay feeding back HARQ information corresponding to a first transport block (TB), or the first message is used to indicate the receiving node to give up feeding back the HARQ information corresponding to the first TB; and the first TB is a transport block scheduled by the first message.

In the method provided in this embodiment of this application, when the first field in the first message is set to be null, both the transmitting node and the receiving node consider by default that feedback of the HARQ information corresponding to the TB scheduled by the first message is given up. In some embodiments, when the first field in the first message is set to be null, both the transmitting node and the receiving node consider by default that feedback of the HARQ information corresponding to the TB scheduled by the first message is delayed. Behavior of the transmitting party and the receiving party is unified by using the first message, to avoid confusion between the behavior of the transmitting party and the receiving party. The transmitting node may retransmit the TB when considering by default that feedback of the HARQ information is given up. This ensures data transmission reliability. In some embodiments, when considering by default that feedback of the HARQ information is delayed, the transmitting node may wait for the HARQ information subsequently sent by the receiving node, instead of retransmitting the TB. This prevents the receiving node from confusing retransmitted data and newly transmitted data, thereby improving data transmission reliability.

In some embodiments, the first message is used to indicate the receiving node to delay feeding back HARQ information corresponding to a first TB, or the first message is used to indicate the receiving node to give up feeding back the HARQ information corresponding to the first TB includes: the first message includes a second field, where when the second field is a first value, the second field is used to indicate the receiving node to delay feeding back the HARQ information corresponding to the first TB; or when the second field is a second value, the second field is used to indicate the receiving node to give up feeding back the HARQ information corresponding to the first TB.

In this embodiment of this application, the second field may be newly added to the first message to indicate behavior of UE. For example, when the second field is “0”, the first message indicates a terminal to give up feeding back corresponding HARQ information; or when the second field is “1”, the first message indicates a terminal to delay feeding back corresponding HARQ information.

In some embodiments, the first message includes a third field, the third field is used to indicate to delay feeding back N pieces of HARQ information, the N pieces of HARQ information include the HARQ information corresponding to the first TB, and N is an integer greater than or equal to two.

In this embodiment of this application, the third field may be newly added to the first message to indicate a quantity of pieces of accumulated HARQ information whose feedback needs to be delayed. For example, when the second field is “00”, the first message indicates a terminal to delay feeding back one corresponding piece of HARQ information; or when the second field is “01”, the first message indicates a terminal to delay feeding back two pieces of HARQ information. By analogy, when one piece of HARQ information whose feedback needs to be delayed is added, the third field increases by one.

In some embodiments, the method includes: sending, by the transmitting node, a second message to the receiving node, where the second message includes a fourth field; the fourth field is used to indicate a feedback resource, and the feedback resource is used to carry the HARQ information corresponding to the first TB and HARQ information corresponding to a second TB; and the second TB is a transport block scheduled by the second message.

In this embodiment of this application, the transmitting node may indicate a terminal to carry HARQ information whose feedback is delayed when the terminal feeds back HARQ information next time. When allocating a time-frequency resource to HARQ information corresponding to a transport block scheduled next time, the transmitting node needs to consider the HARQ information whose feedback is delayed. The allocated feedback resource can carry the HARQ information whose feedback is delayed and the HARQ information corresponding to the transport block scheduled next time.

In some embodiments, the method includes: determining, by the transmitting node based on one or more of a congestion control status of a feedback resource, a quality of service (QoS) requirement, a priority of the first TB, or a feedback feature of the first TB, to set the first field to be null, where the feedback feature of the first TB includes that the first TB is fed back based on a transport block granularity or that the first TB is fed back based on a code block group CBG granularity.

In this embodiment of this application, the transmitting node may determine, based on one or more of the congestion control status, the QoS requirement, the priority of the first TB, or the feedback feature of the first TB, whether feedback of the HARQ information corresponding to the first TB needs to be delayed or the HARQ information corresponding to the first TB is not fed back.

In some embodiments (sometimes referred to as, “a second aspect”), a communications apparatus is disclosed. The communications apparatus may be a transmitting node or a chip in the transmitting node and includes: a processing unit, configured to determine a first message, where a first field in the first message is set to be null, and the first field is used to indicate a time-frequency resource that carries hybrid automatic repeat request HARQ information or information related to the time-frequency resource that carries the HARQ information; and

a communications unit, configured to send the first message to a receiving node, where the first message is used to indicate the receiving node to delay feeding back HARQ information corresponding to a first transport block TB, or the first message is used to indicate the receiving node to give up feeding back the HARQ information corresponding to the first TB; and the first TB is a transport block scheduled by the first message.

In some embodiments, that the first message is used to indicate the receiving node to delay feeding back HARQ information corresponding to a first TB, or the first message is used to indicate the receiving node to give up feeding back the HARQ information corresponding to the first TB includes: the first message includes a second field, where when the second field is a first value, the second field is used to indicate the receiving node to delay feeding back the HARQ information corresponding to the first TB; or when the second field is a second value, the second field is used to indicate the receiving node to give up feeding back the HARQ information corresponding to the first TB.

In some embodiments, the first message includes a third field, the third field is used to indicate to delay feeding back N pieces of HARQ information, the N pieces of HARQ information include the HARQ information corresponding to the first TB, and N is an integer greater than or equal to two.

In some embodiments, the communications unit is configured to send a second message to the receiving node, where the second message includes a fourth field; the fourth field is used to indicate a feedback resource, and the feedback resource is used to carry the HARQ information corresponding to the first TB and HARQ information corresponding to a second TB; and the second TB is a transport block scheduled by the second message.

In some embodiments, the processing unit is configured to determine, based on one or more of a congestion control status of a feedback resource, a QoS requirement, a priority of the first TB, or a feedback feature of the first TB, to set the first field to be null, where the feedback feature of the first TB includes that the first TB is fed back based on a transport block granularity or that the first TB is fed back based on a code block group CBG granularity.

In some embodiments (sometimes referred to as, “a third aspect”), a feedback indication method is disclosed and includes:

receiving, by a receiving node, a first message from a transmitting node, where a first field in the first message is set to be null, and the first field is used to indicate a time-frequency resource that carries hybrid automatic repeat request HARQ information or information related to the time-frequency resource that carries the HARQ information; and the first message is used to indicate the receiving node to delay feeding back HARQ information corresponding to a first TB, or the first message is used to indicate the receiving node to give up feeding back the HARQ information corresponding to the first TB; and the first TB is a transport block scheduled by the first message; and delaying, by the receiving node based on the first message, feeding back the HARQ information corresponding to the first TB; or giving up, based on the first message, feeding back the HARQ information corresponding to the first TB.

In some embodiments, that the first message is used to indicate the receiving node to delay feeding back HARQ information corresponding to a first TB, or the first message is used to indicate the receiving node to give up feeding back the HARQ information corresponding to the first TB includes: the first message includes a second field, where when the second field is a first value, the second field is used to indicate the receiving node to delay feeding back the HARQ information corresponding to the first TB; or when the second field is a second value, the second field is used to indicate the receiving node to give up feeding back the HARQ information corresponding to the first TB.

In some embodiments, the first message includes a third field, the third field is used to indicate to delay feeding back N pieces of HARQ information, the N pieces of HARQ information include the HARQ information corresponding to the first TB, and N is an integer greater than or equal to two.

In some embodiments, the method includes: receiving a second message from the transmitting node, where the second message includes a fourth field; the fourth field is used to indicate a feedback resource, and the feedback resource is used to carry the HARQ information corresponding to the first TB and HARQ information corresponding to a second TB; and the second TB is a transport block scheduled by the second message.

In some embodiments (sometimes referred to as, “a fourth aspect”), a communications apparatus is disclosed, and the communications apparatus may be a receiving node or a chip in the receiving node. The apparatus includes: a communications unit, configured to receive a first message from a transmitting node, where a first field in the first message is set to be null, and the first field is used to indicate a time-frequency resource that carries hybrid automatic repeat request HARQ information or information related to the time-frequency resource that carries the HARQ information; and the first message is used to indicate the receiving node to delay feeding back HARQ information corresponding to a first TB, or the first message is used to indicate the receiving node to give up feeding back the HARQ information corresponding to the first TB; and the first TB is a transport block scheduled by the first message. The communications unit is configured to: delay, based on the first message, feeding back the HARQ information corresponding to the first TB; or give up, based on the first message, feeding back the HARQ information corresponding to the first TB.

In some embodiments, that the first message is used to indicate the receiving node to delay feeding back HARQ information corresponding to a first TB, or the first message is used to indicate the receiving node to give up feeding back the HARQ information corresponding to the first TB includes: the first message includes a second field, where when the second field is a first value, the second field is used to indicate the receiving node to delay feeding back the HARQ information corresponding to the first TB; or when the second field is a second value, the second field is used to indicate the receiving node to give up feeding back the HARQ information corresponding to the first TB.

In some embodiments, the first message includes a third field, the third field is used to indicate to delay feeding back N pieces of HARQ information, the N pieces of HARQ information include the HARQ information corresponding to the first TB, and N is an integer greater than or equal to two.

In some embodiments, the communications unit is configured to receive a second message from the transmitting node, where the second message includes a fourth field; the fourth field is used to indicate a feedback resource, and the feedback resource is used to carry the HARQ information corresponding to the first TB and HARQ information corresponding to a second TB; and the second TB is a transport block scheduled by the second message.

In some embodiments (sometimes referred to as, “a fifth aspect”), a computer-readable storage medium is disclosed. The computer-readable storage medium stores instructions. When the computer-readable storage medium is run on the communications apparatus according to any one of the second aspect and the implementations of the second aspect, the communications apparatus is enabled to perform the method according to any one of the first aspect and the implementations of the first aspect.

In some embodiments (sometimes referred to as, “a sixth aspect”), a computer-readable storage medium is disclosed. The computer-readable storage medium stores instructions. When the computer-readable storage medium is run on the communications apparatus according to any one of the fourth aspect and the implementations of the fourth aspect, the communications apparatus is enabled to perform the method according to any one of the third aspect and the implementations of the third aspect.

In some embodiments (sometimes referred to as, “a seventh aspect”), a wireless communications apparatus is disclosed. The wireless communications apparatus stores instructions, and when the wireless communications apparatus runs on the network device according to any one of the fourth aspect and the implementations of the fourth aspect or any one of the second aspect and the implementations of the second aspect, the network device is enabled to perform the method according to any one of the first aspect and the implementations of the first aspect or any one of the third aspect and the implementations of the third aspect. The wireless communications apparatus is a chip.

In some embodiments (sometimes referred to as, “an eighth aspect”), a communications apparatus is disclosed, including a processor, where the processor is coupled to a memory. The memory is configured to store a computer program. The processor is configured to execute the computer program stored in the memory, to enable the apparatus to perform the method according to any one of the first aspect and the implementations of the first aspect, and according to any one of the third aspect and the implementations of the third aspect.

In some embodiments (sometimes referred to as, “a ninth aspect”), an embodiment of this application provides a chip. The chip includes a processor and an interface circuit, and the interface circuit is coupled to the processor. The processor is configured to run a computer program or instructions, to implement the communications method according to any one of the first aspect and the implementations of the first aspect, and according to any one of the third aspect and the implementations of the third aspect. The interface circuit is configured to communicate with another module other than the chip.

### BRIEF DESCRIPTION OF DRAWINGS

FIG. 1 is a diagram of an architecture of a communications system according to an embodiment of this application;

FIG. 2 is a schematic diagram of resource configuration according to an embodiment of this application;

FIG. 3 is a block diagram of a structure of a communications apparatus according to an embodiment of this application;

FIG. 4 is a schematic flowchart of a feedback indication method according to an embodiment of this application;

FIG. 5 is another schematic flowchart of a feedback indication method according to an embodiment of this application;

FIG. 6 is a schematic flowchart of a feedback indication method according to an embodiment of this application;

FIG. 7 is another block diagram of a structure of a communications apparatus according to an embodiment of this application; and

FIG. 8 is another block diagram of a structure of a communications apparatus according to an embodiment of this application.

### DESCRIPTION OF EMBODIMENTS

The following describes the technical solutions of this application with reference to the accompanying drawings.

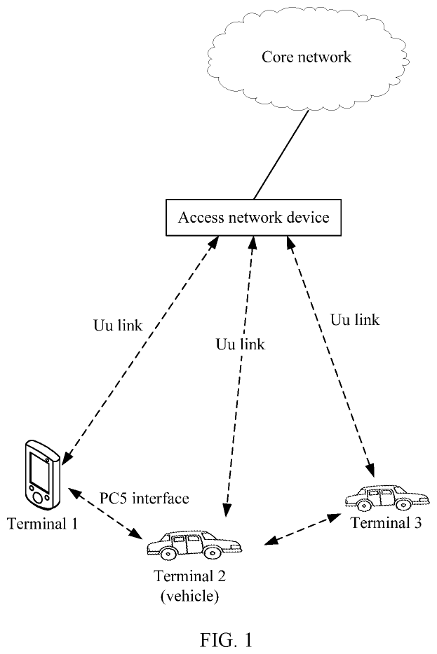

A method provided in the embodiments of this application may be applied to a communications apparatus shown in FIG. 1. The communications system may be a 3rd generation partnership project (3GPP) communications system, for example, a long term evolution (LTE) system, or may be a 5th generation mobile communications system or a new radio (NR) system, or may be a non-3GPP communications system. This is not limited in the embodiments of this application.

Refer FIG. 1. The communications system may include a plurality of terminals, an access network device, a core network, and the like. Sidelink communication may be performed between the terminals through a PC5 interface, and a communications link between the terminals is referred to as a sidelink (SL). The access network device and the terminal may communicate with each other through a Uu link.

The terminal may be user equipment (UE), an access terminal, a UE unit, UE station, a mobile station, a remote station, a remote terminal, a mobile device, a UE terminal, a wireless communications device, a UE agent, a UE apparatus, or the like. The access terminal may be a cellular phone, a cordless phone, a session initiation protocol (SIP) phone, a wireless local loop (WLL) station, a personal digital assistant (PDA), a handheld device having a wireless communications function, a computing device, another processing device connected to a wireless modem, a vehicle-mounted device, a wearable device, a terminal in a 5G network, a terminal in a future evolved public land mobile network (PLMN) network, or the like. The terminal in the embodiments of this application may include but is not limited to a vehicle-mounted terminal, a mobile phone, a tablet computer, a computer having a wireless transceiver function, a smart gas station, a smart signal light, and the like.

The access network device may be a transmission reception point (TRP), a base station, a relay station, a node, an access point, or the like. The access network device may be an access network device in a 5G communications system or an access network device in a future evolved network, or may be a wearable device, a vehicle-mounted device, or the like. In some embodiments, the network device may alternatively be a base transceiver station (BTS) in a global system for mobile communications (GSM) or code division multiple access (CDMA) network, an NB (NodeB) in a wideband code division multiple access (WCDMA) network, or an eNB or eNodeB (evolutional NodeB) in a long term evolution (LTE) network. The access network device 100 may alternatively be a radio controller in a cloud radio access network (CRAN) scenario. The following uses a base station as an example for description in this application.

It should be noted that the network architecture shown in FIG. 1 is merely an example of a diagram of an architecture, but a quantity of network elements included in the communications system shown in FIG. 1 is not limited. In addition to the network functional entities shown in FIG. 1, the network shown in FIG. 1 may include another functional entity, although the another functional entity is not shown in FIG. 1. In some embodiments, names of network elements and names of interfaces between the network elements in the network architecture shown in FIG. 1 are merely examples. In a specific implementation, the names of the network elements and the names of the interfaces between the network elements may be other names. This is not limited in the embodiments of this application. In some embodiments, the method provided in the embodiments of this application may be applied to the communications system shown in FIG. 1, and is also applicable to another HARQ technology network or system. This is not limited in the embodiments of this application.

The embodiments of this application are applicable to transmission between terminals. For example, both a receiving node and a transmitting node in the embodiments of this application are terminals. The embodiments of this application are also applicable to a communications system that supports an unlicensed spectrum, that is, the embodiments of this application are applicable to transmission between an access network device and a terminal. For example, in the embodiments of this application, the transmitting node is an access network device, and the receiving node is a terminal; or the transmitting node is a terminal, and the receiving node is an access network device.

For ease of understanding, terms in the embodiments of this application are explained and described.

(1) HARQ

HARQ means that the receiving node needs to feedback 1-bit HARQ information to the transmitting node, to indicate whether a TB sent by the transmitting node is successfully received by the receiving node. In some embodiments, if the transmitting node determines that the receiving node fails to receive the TB, the transmitting node may retransmit the TB to the receiving node.

For example, the transmitting node sends a TB to the receiving node. If the receiving node successfully receives the TB, the receiving node feeds back a 1-bit ACK to the transmitting node, to indicate that the receiving node successfully receives the TB. In some embodiments, if the receiving node fails to receive the TB, the receiving node feeds back a 1-bit NACK to the transmitting node, to indicate that the receiving node successfully receives the TB. After receiving the NACK from the receiving node, the transmitting node may retransmit the TB to the receiving node.

It should be noted that in the embodiments of this application, the 1-bit NACK or the 1-bit ACK may be referred to as HARQ information. For example, the ACK is “1”, and the NACK is “0”.

(2) Physical sidelink feedback channel (PSFCH), physical sidelink control channel (PSCCH), and physical sidelink shared channel (PSSCH)

The PSCCH is a control channel for sidelink communication between terminals. For example, the terminals may send control signaling to each other by using the PSCCH to schedule data.

The PSSCH is a data channel for sidelink communication between terminals. For example, the terminals may send data to each other by using the PSSCH.

The PSFCH is a channel for feeding back HARQ information between terminals. For example, the terminal may send a 1-bit NACK or a 1-bit ACK by using the PSFCH.

(3) PSFCH Timeslot

In the embodiments of this application, the PSFCH timeslot is a timeslot in which a terminal can send the PSFCH.

In some embodiments, there is an implicit association between the PSFCH timeslot and the PSCCH/PS SCH. For example, a fixed time interval K is used between the PSSCH and the PSFCH. For example, if the terminal sends the PSSCH in a timeslot X, the terminal may send the PSFCH in a timeslot X+K or a first timeslot that is after the timeslot X+K and in which a PSFCH feedback resource exists. For example, it is assumed that the time interval between the PSCCH and the PSFCH is two, and it is assumed that the PSSCH is sent in the timeslot X. In this case, the terminal may send the PSFCH in a first timeslot that is in timeslots X+2, X+3 . . . and in which the PSFCH feedback resource exists, but cannot send the PSFCH in timeslots X and X+1 even if the PSFCH feedback resource exists in the timeslots X and X+1.

(4) PSFCH Resource

In the embodiments of this application, the PSFCH resource is a time-frequency resource used by a terminal to send the PSFCH. The PSFCH resource is periodically configured. When the time interval K is fixed, there may be no available SL resource in the PSFCH timeslot, or there may be an available SL resource in the PSFCH timeslot, but no available PSFCH resource is obtained.

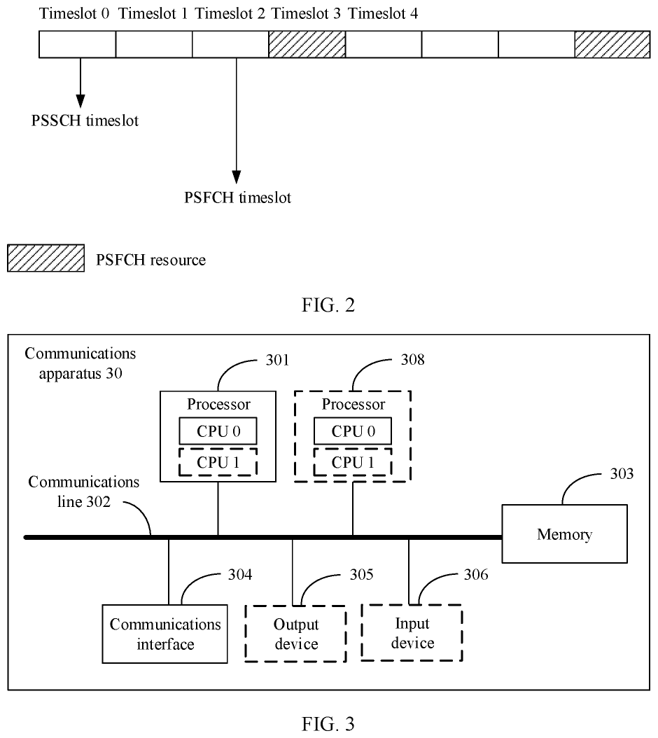

For example, refer to FIG. 2. It is assumed that one PSFCH resource is configured for every four timeslots, and the time interval K is equal to two. The terminal sends the PSSCH in a timeslot 1, and a timeslot 3 is the PSFCH timeslot. However, there is no available PSFCH resource in the timeslot 3.

The transmitting node and the receiving node in the embodiments of the present disclosure may be implemented by using a communications apparatus 30 in FIG. 3. FIG. 3 is a schematic diagram of a hardware structure of the communications apparatus 30 according to an embodiment of this application. The communications apparatus 30 includes a processor 301, a communications line 302, a memory 303, and at least one communications interface (where description is provided in FIG. 3 merely by using an example in which the communications apparatus 30 includes a communications interface 304).

The processor 301 may be a general-purpose central processing unit (CPU), a microprocessor, an application-specific integrated circuit (ASIC), or one or more integrated circuits configured to control program execution of the solutions in this application.

The communications line 302 may include a path for transmitting information between the foregoing components.

The communications interface 304 is applicable to any apparatus such as a transceiver, and is configured to communicate with another device or a communications network such as the Ethernet, a radio access network (RAN), or a wireless local area network (WLAN).

The memory 303 may be a read-only memory (ROM) or another type of static storage device that can store static information and instructions, a random access memory (RAM) or another type of dynamic storage device that can store information and instructions, or may be an electrically erasable programmable read-only memory (EEPROM), a compact disc read-only memory (CD-ROM) or another optical disc storage, an optical disc storage (including a compressed optical disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer, but is not limited thereto. The memory may exist independently, and be connected to the processor through the communications line 302. In some embodiments, the memory may be integrated with the processor.

The memory 303 is configured to store computer-executable instructions for executing the solutions of this application, and the processor 301 controls the execution. The processor 301 is configured to execute the computer-executable instructions stored in the memory 303, to implement the intent processing method provided in the following embodiments of this application.

In some embodiments, the compute-executable instructions in the embodiments of this application may also be referred to as application program code. This is not limited in the embodiments of this application.

In a specific implementation, in an embodiment, the processor 301 may include one or more CPUs, for example, a CPU 0 and a CPU 1 in FIG. 3.

In a specific implementation, in an embodiment, the communications apparatus 30 may include a plurality of processors, for example, the processor 301 and a processor 308 in FIG. 3. Each of the processors may be a single-core (e.g., single-CPU) processor, or may be a multi-core (e.g., multi-CPU) processor. The processor herein may be one or more devices, circuits, and/or processing cores for processing data (for example, computer program instructions).

In a specific implementation, in an embodiment, the communications apparatus 30 may include an output device 305 and an input device 306. The output device 305 communicates with the processor 301, and may display information in a plurality of manners. For example, the output device 305 may be a liquid crystal display (LCD), a light emitting diode (LED) display device, a cathode ray tube (CRT) display device, a projector, or the like. The input device 306 communicates with the processor 301, and may receive an input of a user in a plurality of manners. For example, the input device 306 may be a mouse, a keyboard, a touchscreen device, a sensing device, or the like.

The communications apparatus 30 may be a general-purpose device or a special-purpose device. In a specific implementation, the communications apparatus 30 may be a desktop computer, a portable computer, a network server, a palmtop computer, a mobile phone, a tablet computer, a wireless terminal device, an embedded device, or a device having a similar structure in FIG. 3. A type of the communications apparatus 30 is not limited in the embodiments of this application.

The following describes in detail the solutions provided in the embodiments of this application with reference to accompanying drawings.

It should be noted that, in the following embodiments of this application, names of messages or names of parameters in messages between devices are merely examples, and the messages or the parameters may have other names in specific implementations. This is not limited in the embodiments of this application.

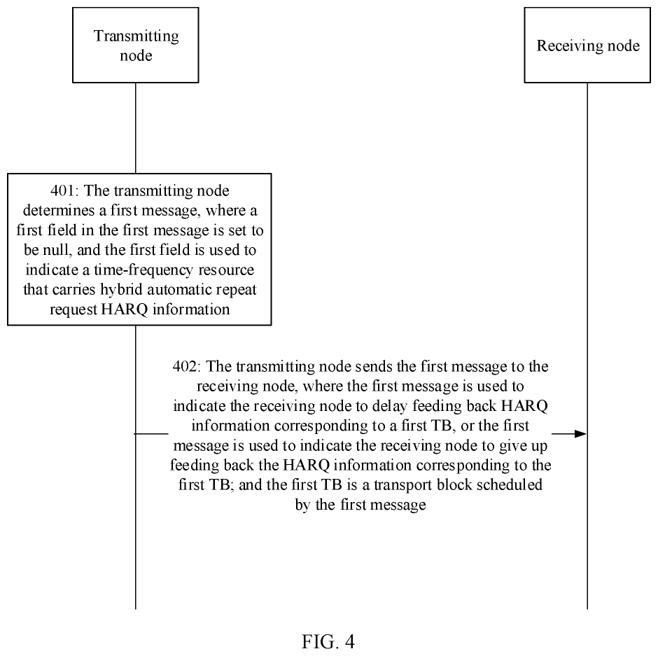

An embodiment of the present disclosure provides a monitoring method. As shown in FIG. 4, the method includes the following operations.

401: A transmitting node determines a first message, where a first field in the first message is set to be null, and the first field is used to indicate a time-frequency resource that carries hybrid automatic repeat request HARQ information.

It should be noted that in this embodiment of this application, the transmitting node may be a terminal or may be an access network device, and a receiving node may be a terminal. That the first field in the first message is set to be null means that the first field is reserved in the first message and the first field is an absent state. For example, no specific value is filled in the first field.

In some embodiments, the transmitting node is an access network device, the receiving node is a terminal, the first message may be control signaling, and the transmitting node sends the first message to the receiving node through a Uu link.

In some embodiments, the transmitting node is a terminal, the receiving node is a terminal, the first message may be sidelink control information (SCI), and the transmitting node sends the first message to the receiving node through a PC5 interface.

In specific implementation, the transmitting node determines, based on one or more of the following several factors, whether to set the first field to be null: a congestion control status of a feedback resource, a quality of service (QoS) requirement, a priority of a to-be-sent TB, or a feedback feature of the to-be-sent TB. It should be noted that when the transmitting node determines whether to set the first field to be null, factors that may be considered by the transmitting node include but are not limited to the foregoing several factors, and the transmitting node may alternatively determine, based on another determining factor, to set the first field to be null.

For example, a node 1 receives a TB 1 sent by a node 3, and needs to feedback corresponding HARQ information in a specific PSFCH feedback timeslot. Then, the node 1 sends a TB 2 to a node 2, and needs to feedback corresponding HARQ information in the same PSFCH feedback timeslot. Due to a limitation of half-duplex, the node 1 cannot simultaneously send and receive a PSFCH in a same PSFCH feedback timeslot. It is assumed that priorities (and/or QoS requirements) of the TB 1 and the TB 2 are different, and a priority (and/or a QoS requirement) of the TB 1 is/are higher than that of the TB 2. The node 1 sends the PSFCH to the node 3. The node 1 cannot receive the PSFCH of the node 2, and sets the first field in the first message to be null, to implicitly indicate the node 2 to give up feeding back HARQ information, or implicitly indicate the node 2 to delay feeding back the HARQ information. In some embodiments, the node 1 adds a third field to the first message, to indicate the node 2 to delay or give up feeding back HARQ information.

For example, a node 1 receives a TB 1 sent by a node 3, and needs to feedback corresponding HARQ information in a specific PSFCH feedback timeslot based on a CBG. Then, the node 1 sends a TB 2 to a node 2, and needs to feedback corresponding HARQ information in the same PSFCH feedback timeslot based on a TB. Due to a limitation of half-duplex, the node 1 cannot simultaneously send and receive a PSFCH in a same PSFCH feedback timeslot. If a priority of feedback based on a CBG granularity is higher than a priority of feedback based on a TB granularity, the node 1 sends the PSFCH to the node 3. The node 1 cannot receive the PSFCH of the node 2, and the node 1 sets the first field in the first message to be null, to implicitly indicate the node 2 to give up feeding back HARQ information, or implicitly indicate the node 2 to delay feeding back the HARQ information. In some embodiments, the node 1 adds a third field to the first message, to indicate the node 2 to delay or give up feeding back HARQ information.

For example, a node 1 receives a TB 1 of a node 3, and needs to feedback corresponding HARQ information in a specific PSFCH feedback timeslot based on a CBG. Then, the node 1 sends a TB 2 to a node 2, and needs to feedback corresponding HARQ information in the same PSFCH feedback timeslot based on a TB. Due to a limitation of half-duplex, the node 1 cannot simultaneously send and receive a PSFCH in a same PSFCH feedback timeslot. If a priority of feedback based on a CBG granularity is higher than a priority of feedback based on a TB granularity, the node 1 sends the PSFCH to the node 3. The node 1 cannot receive the PSFCH of the node 2, and the node 1 sets the first field in the first message to be null, to implicitly indicate the node 2 to give up feeding back HARQ information, or implicitly indicate the node 2 to delay feeding back the HARQ information. In some embodiments, the node 1 adds a third field to the first message, to indicate the node 2 to delay or give up feeding back HARQ information.

For example, a node 1 receives a TB 1 of a node 3, and needs to feedback corresponding HARQ information in a specific PSFCH feedback timeslot based on a TB. Then, the node 1 sends a TB 2 to a node 2, and needs to feedback corresponding HARQ information in the same PSFCH feedback timeslot based on a TB. Due to a limitation of half-duplex, the node 1 cannot simultaneously send and receive a PSFCH in a same PSFCH feedback timeslot. It is assumed that an upper limit of a congestion control parameter CR (e.g., channel occupancy ratio) of the node 1 is higher. This means that the node 1 has a higher priority of sending a service. In this case, the node 1 sends the PSFCH to the node 3. The node 1 cannot receive the PSFCH of the node 2, and sets the first field in the first message to be null, to implicitly indicate the node 2 to give up feeding back HARQ information, or implicitly indicate the node 2 to delay feeding back the HARQ information. In some embodiments, the node 1 adds a third field to the first message, to indicate the node 2 to delay or give up feeding back HARQ information.

It should be noted that a feedback feature of a TB includes that the TB is fed back based on a transport block granularity, or the TB is fed back based on a code block group (CBG) granularity.

402: The transmitting node sends the first message to the receiving node, where the first message is used to indicate the receiving node to delay feeding back HARQ information corresponding to a first TB, or the first message is used to indicate the receiving node to give up feeding back the HARQ information corresponding to the first TB; and the first TB is a transport block scheduled by the first message.

In some embodiments, once the first field in the first message is set to be null, it is considered by default that behavior performed by the receiving node after the receiving node receives the first message is giving up feeding back the HARQ information corresponding to the first TB. In some embodiments, once the first field in the first message is set to be null, it is considered by default that behavior performed by the receiving node after the receiving node receives the first message is delaying feeding back the HARQ information corresponding to the first transport block TB.

It should be noted that, that the receiving node gives up feeding back the HARQ information corresponding to the first TB may be considered as: The receiving node does not generate the HARQ information corresponding to the first TB, or the receiving node disables an HARQ function.

That the receiving node delays feeding back the HARQ information corresponding to the first TB may be considered as: The receiving node sends, on a next available PSFCH resource, the HARQ information corresponding to the first TB.

It can be understood that the HARQ information corresponding to the first TB is used to indicate a result of receiving the first TB by the receiving node. For example, the receiving node fails to receive the first TB, or the receiving node successfully receives the first TB.

In some embodiments, the HARQ information corresponding to the first TB has 1 bit: “0” or “1”.

In some embodiments, the first message may include a second field, and the second field is used to indicate the receiving node to delay feeding back HARQ information or give up feeding back the HARQ information.

For example, when the second field is a first value, the second field is used to indicate the receiving node to delay feeding back the HARQ information corresponding to the first TB; or when the second field is a second value, the second field is used to indicate the receiving node to give up feeding back the HARQ information corresponding to the first TB.

In some embodiments, the first field has 1 bit. When the 1 bit is “0”, the first message is used to indicate a terminal to delay feeding back the HARQ information corresponding to the first TB; or when the 1 bit is “1”, the first message is used to indicate the terminal to give up feeding back the HARQ information corresponding to the first TB.

In some embodiments, when the first message indicates the receiving node to delay feeding back the HARQ information, and the transmitting node sends more than one such first message, the receiving node may send, on a next available PSFCH resource, a plurality of pieces of HARQ information whose feedback is delayed.

In some embodiments, the first message may include a third field, the third field is used to indicate to delay feeding back N pieces of HARQ information, and the N pieces of HARQ information include the HARQ information corresponding to the first TB. For example, the third field may have N bits, and the first message indicates that the receiving node can delay feeding back a maximum of 2^{N} pieces of HARQ information.

In some embodiments, the method shown in FIG. 4 includes the following: The transmitting node sends a second message to the receiving node. The second message includes a fourth field; the fourth field is used to indicate a feedback resource, and the feedback resource is used to carry the HARQ information corresponding to the first TB and HARQ information corresponding to a second TB; and the second TB is a transport block scheduled by the second message.

It should be noted that the fourth field and the first field may be a same field and each are used to indicate a PSFCH resource. When the first message indicates the receiving node to delay feeding back the first TB, the transmitting node may indicate, in a control message for scheduling a TB (that is, the second TB) next time, a PSFCH resource used to feedback the HARQ information corresponding to the first TB and the HARQ information corresponding to the second TB.

In some embodiments, when the first field in the first message is set to be null, it is considered by default that the receiving node does not feedback the HARQ information corresponding to the first TB. In this case, the transmitting node retransmits the first TB, or the transmitting node blindly transmits the first TB. Blind transmission is repeated data transmission without HARQ feedback, and data transmission reliability is improved through repeated data transmission.

In the method provided in this embodiment of this application, when the first field in the first message is set to be null, both the transmitting node and the receiving node consider by default that feedback of the HARQ information corresponding to the TB scheduled by the first message is given up. In some embodiments, when the first field in the first message is set to be null, both the transmitting node and the receiving node consider by default that feedback of the HARQ information corresponding to the TB scheduled by the first message is delayed. Behavior of the transmitting party and the receiving party is unified by using the first message, to avoid confusion between the behavior of the transmitting party and the receiving party. The transmitting node may retransmit the TB when considering by default that feedback of the HARQ information is given up. This ensures data transmission reliability. In some embodiments, when considering by default that feedback of the HARQ information is delayed, the transmitting node may wait for the HARQ information subsequently sent by the receiving node, instead of retransmitting the TB. This prevents the receiving node from confusing retransmitted data and newly transmitted data, thereby improving data transmission reliability.

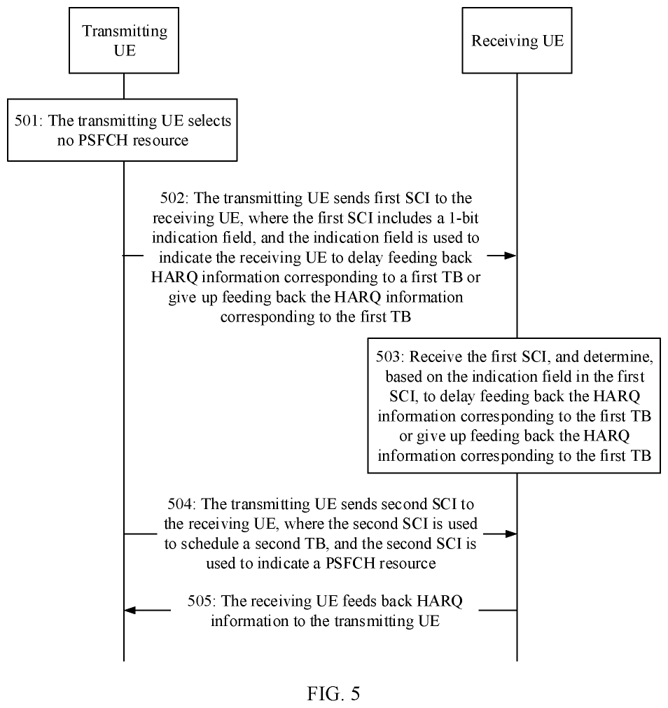

The method provided in the embodiments of this application is described below with reference to the accompanying drawings by using an example in which the transmitting node is UE and the receiving node is UE. As shown in FIG. 5, the method includes the following operations.

501: The transmitting UE selects no PSFCH resource.

In an embodiment, when the transmitting UE sends a first TB to the receiving UE, the transmitting UE may select a data resource and a PSFCH resource from an SL resource pool. Specifically, after selecting the data resource, the transmitting UE may send the first TB on the selected data resource.

If no PSFCH resource is selected in a PSSCH-to-PSFCH time interval (that is, the time interval K described in the embodiments of this application) and a first timeslot that is after the PSSCH-to-PSFCH time interval and in which a PSFCH resource exists, it is determined that no PSFCH resource is selected. After receiving the first TB, the receiving UE has no PSFCH resource to feedback HARQ information corresponding to the first TB.

502: The transmitting UE sends first SCI to the receiving UE, where the first SCI includes a 1-bit indication field, and the indication field is used to indicate the receiving UE to delay feeding back the HARQ information corresponding to the first TB or give up feeding back the HARQ information corresponding to the first TB.

It should be noted that the 1-bit indication field is a newly added field in SCI. In some embodiments, when the indication field is “0”, the first SCI is used to indicate the receiving UE to give up feeding back the HARQ information corresponding to the first TB; or when the indication field is “1”, the first SCI is used to indicate the receiving UE to delay feeding back the HARQ information corresponding to the first TB.

503: The receiving UE receives the first SCI, and determines, based on the indication field in the first SCI, to delay feeding back the HARQ information corresponding to the first TB or give up feeding back the HARQ information corresponding to the first TB.

If the indication field indicates the receiving UE to give up feeding back the HARQ information corresponding to the first TB, the receiving UE does not generate the feedback HARQ information corresponding to the first TB.

In some embodiments, if the indication field indicates the receiving UE to delay feeding back the HARQ information corresponding to the first TB, the receiving UE generates the HARQ information corresponding to the first TB; and sends, on a next available PSFCH resource, the HARQ information corresponding to the first TB.

504: The transmitting UE sends second SCI to the receiving UE, where the second SCI is used to schedule a second TB, and the second SCI is used to indicate a PSFCH resource.

It should be noted that if the first SCI indicates the receiving UE to delay feeding back the HARQ information corresponding to the first TB, when sending SCI to indicate a feedback resource next time, the transmitting UE needs to consider the HARQ information corresponding to the first TB. In other words, the PSFCH resource indicated by the second SCI is used to carry the HARQ information corresponding to the first TB and HARQ information corresponding to the second TB.

For example, the HARQ information corresponding to the first TB has 1 bit, the HARQ information corresponding to the second TB has 1 bit, and the PSFCH resource indicated by the second SCI may carry 2-bit information.

In some embodiments, if the first SCI indicates the receiving UE to give up feeding back the HARQ information corresponding to the first TB, when sending SCI to indicate a feedback resource next time, the transmitting UE may not need to consider the HARQ information corresponding to the first TB. In other words, the PSFCH resource indicated by the second SCI is used to carry HARQ information corresponding to the second TB.

For example, the HARQ information corresponding to the second TB has 1 bit, and the PSFCH resource indicated by the second SCI may carry 1-bit information.

505: The receiving UE feeds back HARQ information to the transmitting UE.

It is assumed that the first SCI indicates the receiving UE to delay feeding back the HARQ information corresponding to the first TB. The HARQ information fed back by the receiving UE in operation 505 has 2 bits, and includes the HARQ information corresponding to the second TB and the HARQ information corresponding to the first TB.

In some embodiments, it is assumed that the first SCI indicates the receiving UE to give up feeding back the HARQ information corresponding to the first TB. The HARQ information fed back by the receiving UE in operation 505 has 1 bit, and includes the HARQ information corresponding to the second TB.

In some embodiments, to ensure a delay requirement for data transmission, the transmitting UE may set a feedback time limit window, and the transmitting UE expects to receive, in the time limit window, HARQ information whose feedback is delayed. Once the time limit window is exceeded, the transmitting UE does not expect to receive the HARQ information whose feedback is delayed. When the time limit window is exceeded, the receiving UE may not generate the HARQ information and not send the HARQ information.

The feedback time limit window may be configured by a network side based on information such as delay reliability QoS of a service.

In some embodiments, when sending a TB, the transmitting UE sets a timer for the TB. Before the timer of the TB ends timing, the transmitting UE expects to receive HARQ information whose feedback is delayed. If after the timer ends, a delay requirement for the TB cannot be met, the transmitting UE does not expect to receive the corresponding HARQ information.

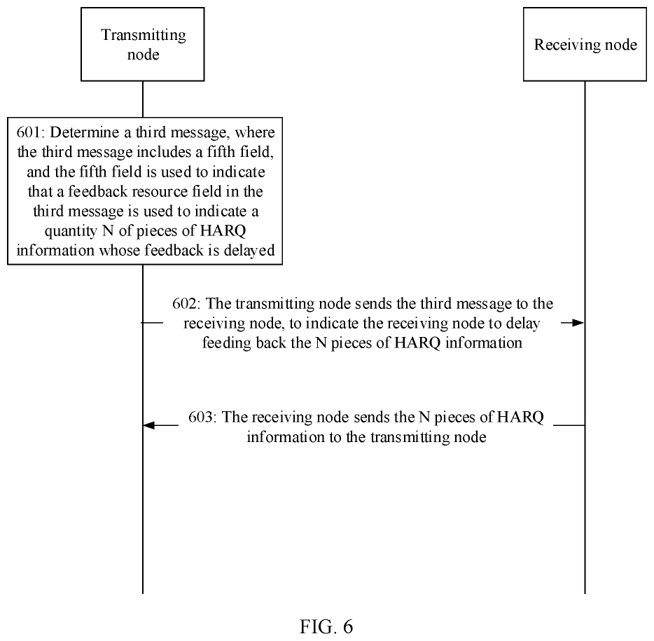

An embodiment of this application provides a feedback indication method in which a field that is in control information and that indicates a feedback resource may be multiplexed to indicate a quantity of pieces of HARQ information whose feedback is delayed. In other words, a receiving node may feedback a plurality of pieces of HARQ information together. As shown in FIG. 6, the method includes the following operations.

601: A transmitting node determines a third message, where the third message includes a fifth field, and the fifth field is used to indicate that a feedback resource field in the third message is used to indicate a quantity N of pieces of HARQ information whose feedback is delayed.

It should be noted that the feedback resource field may be used to indicate a time-frequency resource that carries HARQ information, or the feedback resource field indicates information related to the time-frequency resource that carries the HARQ information. For example, the related information may be an index corresponding to the time-frequency resource, that is, the index corresponding to the time-frequency resource indicated by the feedback resource field. The time-frequency resource that carries the HARQ information may be determined from a configured time-frequency resource set based on the index, or a PSFCH feedback resource is obtained through mapping based on the index from a PSFCH feedback resource corresponding to a plurality of transport blocks.

For example, the fifth field is the first field in the first message in the embodiments of this application, or the fourth field in the second message in the embodiments of this application.

When the third message indicates the receiving node to delay feeding back the HARQ information, the feedback resource field no long indicates the time-frequency resource that carries the HARQ information, and may be used to indicate the quantity N of pieces of HARQ information whose feedback needs to be delayed. In some embodiments, the fifth field needs to be added to indicate an actual function of the feedback resource field.

For example, the fifth field has 1 bit. When the fifth field is “0”, the feedback resource field is used to indicate the time-frequency resource that carries the HARQ information; or when the fifth field is “1”, the feedback resource field is used for the quantity N of pieces of HARQ information whose feedback needs to be delayed.

In some embodiments, the feedback resource field may have N bits, and the first message indicates that the receiving node can delay feeding back a maximum of 2^{N} pieces of HARQ information.

602: The transmitting node sends the third message to the receiving node, to indicate the receiving node to delay feeding back the N pieces of HARQ information.

603: The receiving node sends the N pieces of HARQ information to the transmitting node.

Specifically, the receiving node may send the N pieces of HARQ information to the transmitting node by using an available PSFCH resource.

In some embodiments, it is assumed that transport blocks whose feedback needs to be delayed are: a TB 1, a TB 2, and a TB 3, and HARQ information corresponding to the TB 1, the TB 2, and the TB 3 is: an ACK, a NACK, and an ACK. The HARQ information sent by the receiving node in operation 603 is the ACK, the NACK, and the ACK.

In some embodiments, the HARQ information corresponding to the TB 1, the TB 2, and the TB 3 may be placed, for sending, in a same HARQ-ACK codebook with HARQ information that is currently normally fed back. The HARQ information that is currently normally fed back may be placed in a header or a tail of the HARQ-ACK codebook, and a total quantity of bits of HARQ information in the HARQ-ACK codebook is four.

In some embodiments, the receiving node may correct, based on a count field, an error caused by a loss of HARQ information. The count field may be the feedback resource field. In this scenario, the feedback resource field no longer indicates the time-frequency resource that carries the HARQ information, but is used to indicate a quantity of pieces of HARQ information whose feedback is delayed.

The count field may alternatively be a newly added field, for example, the third field in this embodiment of this application.

For example, the transmitting node sends SCI 1 to the receiving node to indicate the receiving node to delay feeding back the TB 1. A count field in the SCI 1 is denoted as a counter-DFI 1. The counter-DFI 1 may be “00”, indicating that feedback of one piece of HARQ information needs to be delayed, that is, the HARQ information corresponding to the TB 1. Then, the transmitting node sends SCI 2 to the receiving node to indicate the receiving node to delay feeding back the TB 2. A count field in the SCI 2 is denoted as a counter-DFI 2. The counter-DFI 2 may be “01”, indicating that feedback of two pieces of HARQ information needs to be delayed, that is, the HARQ information corresponding to the TB 1 and the HARQ information corresponding to the TB 2. When a counter-DFI in SCI received by the receiving node is “11”, indicating to delay feeding back a TB 4, but the receiving node does not receive SCI whose counter-DFI is “10”, the receiving party may know, by using the counter-DFI field, that the receiving party loses a data block (for example, the TB 3) between the TB 2 and the TB 4, and fills the NACK at a corresponding location when feeding back the HARQ information.

In some embodiments, a counter-DFI in SCI received by the receiving node is “11”, that is, the counter-DFI indicates that the node needs to delay feeding back four pieces of HARQ information: the HARQ information corresponding to the TB 1, the HARQ information corresponding to the TB 2, the HARQ information corresponding to the TB 3 (e.g., a lost data block), and HARQ information corresponding to a TB 4. It is assumed that the receiving node successfully receives the TB 2 and the TB 4, and needs to retransmit the TB 1. To be specific, the HARQ information corresponding to the TB 1 is “0”, the HARQ information corresponding to the TB 2 is “1”, and the HARQ information corresponding to the TB 4 is “1”. In some embodiments, because the TB 3 is the lost data block, it is considered by default that the HARQ information corresponding to the TB 3 is “0”. HARQ information whose feedback is delayed by the receiving node is “0101”. The four bits sequentially correspond to the four data blocks: the TB 1 to the TB 4.

In some embodiments, an accumulation sequence in a counter-DFI field complies with a rule of first frequency domain and then time domain. For example, a sub-channel with a minimum sub-channel sequence number is first determined, or a sub-channel with a lowest frequency domain may be first determined, for example, a sub-channel 1. A first SCI detection location (e.g., a location at which the SCI is first detected in a timeslot) on the sub-channel 1 is fixed, and HARQ information corresponding to the first SCI detection location is first accumulated in the counter-DFI field. For example, a counter-DFI field 00 represents that feedback of the HARQ information is delayed. In some embodiments, all sub-channels are traversed. HARQ information corresponding to SCI detection locations that are on the remaining sub-channels and that have a start location the same as that of the SCI detection location at which the SCI is first detected is accumulated in the counter-DFI field in ascending order of sequence numbers of the sub-channels (or in ascending order of frequency domains of the sub-channels). For example, HARQ information corresponding to a sub-channel 2 is the second one that is accumulated in the counter-DFI field. For example, a counter-DFI field 01 represents that feedback of the HARQ information is delayed. HARQ information corresponding to a sub-channel 3 is the third one that is accumulated in the counter-DFI field. For example, a counter-DFI field 10 represents feedback of the HARQ information is delayed. Then, second SCI whose start location is the earliest is determined from the remaining SCI, and the foregoing operation is repeated. The rest may be deduced by analogy.

It should be noted that the counter-DFI field, that is, a counter-Delay feedback indicator field, may be the third field in this embodiment of this application.

In some embodiments, if the transmitting node selects no PSFCH resource when sending a TB, the transmitting node retransmits the TB. Data transmission reliability is ensured by repeatedly sending data. Specifically, a quantity of times of retransmitting the TB may be determined based on a QoS parameter of the TB and/or congestion control information of a resource.

In some embodiments, the quantity of times of retransmitting the TB may alternatively be dynamically indicated in the SCI.

In some embodiments, if the transmitting node selects no PSFCH resource when sending a TB, the transmitting node indicates the receiving node to delay feeding back HARQ information corresponding to the TB. The receiving node feeds back, on a next available PSFCH resource, the HARQ information corresponding to the TB.

In some embodiments, the transmitting node may indicate, in the SCI to the receiving node, a resource for feeding back HARQ information (e.g., HARQ information whose feedback needs to be delayed).

In some embodiments, the first field in the first message is set to be null, to indicate the receiving node to delay feeding back HARQ information. HARQ information whose feedback is delayed by the receiving node may be carried on a PSCCH, a PSSCH, or a PSFCH.

In some embodiments, the first field in the first message is set to be null, to indicate the receiving node to delay feeding back HARQ information. The transmitting node may add a field to indicate whether the HARQ information whose feedback is delayed by the receiving node can be carried on the PSCCH or the PSSCH channel. It is assumed that the field indicates that the HARQ information whose feedback is delayed by the receiving node can be carried on the PSCCH or the PSSCH channel. The transmitting node expects to receive, on a received PSCCH or PSSCH before receiving a next corresponding PSFCH, the corresponding HARQ information whose feedback is delayed.

For example, the receiving node and the transmitting node consider by default that the PSCCH, the PSSCH, or the PSFCH carry the HARQ information whose feedback is delayed, but the transmitting node may be unable to determine a specific channel on which the HARQ information is included.

In some embodiments, before feeding back HARQ information next time, the receiving node sends data or a CSI measurement report to the transmitting node, and the receiving node may carry, on the PSSCH, the HARQ information whose feedback is delayed. In some embodiments, an HARQ process number may be carried to identify different HARQ information.

In some embodiments, the transmitting node may indicate, to the receiving node by using 1 or 2 bits in the SCI, a specific channel for carrying the HARQ information whose feedback is delayed. For example, “00” is used to indicate the receiving node to carry, on the PSCCH, the HARQ information whose feedback is delayed; “01” is used to indicate the receiving node to carry, on the PSSCH, the HARQ information whose feedback is delayed; and “10” is used to indicate the receiving node to carry, on the PSFCH, the HARQ information whose feedback is delayed.

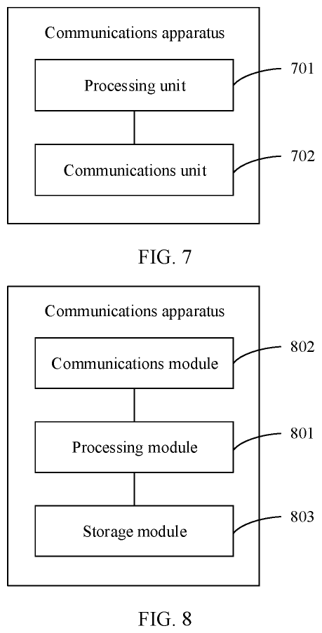

When function modules are obtained through division based on each corresponding function, FIG. 7 is a possible schematic diagram of a structure of the communications apparatus in the foregoing embodiments. The communications apparatus shown in FIG. 7 may be the transmitting node (or the receiving node) in the embodiments of this application, or may be a component that is in the transmitting node (or the receiving node) and that implements the foregoing method, or may be a chip applied to the transmitting node (or the receiving node). The chip may be a system-on-a-chip (SOC), a baseband chip having a communications function, or the like. As shown in FIG. 7, the communications apparatus includes a processing unit 701 and a communications unit 702. The processing unit may be one or more processors, and the communications unit may be a transceiver.

The processing unit 701 is configured to support the transmitting node in performing operation 401, operation 501, operation 601, and/or another process of the technology described in this specification.

The communications unit 702 is configured to support communication between the communications apparatus and another communications apparatus, for example, support the transmitting node (or the receiving node) in performing operation 402, operation 502, operation 504, operation 505, operation 602, operation 603, and/or another process of the technology described in this specification.

It should be noted that all related content of the operations in the foregoing method embodiments may be cited in function description of corresponding function modules. Details are not described herein again.

For example, when an integrated unit is used, FIG. 8 is a schematic diagram of a structure of a communications apparatus according to an embodiment of this application. In FIG. 8, the communications apparatus includes a processing module 801 and a communications module 802. The processing module 801 is configured to control and manage actions of the communications apparatus, for example, perform the operation performed by the processing unit 701, and/or another process of the technology described in this specification. The communications module 802 is configured to: perform the operation performed by the communications unit 702, and support interaction between the communications apparatus and another device, for example, interaction with another terminal apparatus. As shown in FIG. 8, the communications apparatus may include a storage module 803, and the storage module 803 is configured to store program code and data of the communications apparatus.

When the processing module 801 is a processor, the communications module 802 is a transceiver, and the storage module 803 is a memory, the communications apparatus is the communications apparatus shown in FIG. 3.

An embodiment of this application provides a computer-readable storage medium. The computer-readable storage medium stores instructions. The instructions are used to perform the methods shown in FIG. 4 to FIG. 6.

An embodiment of this application provides a computer program product including instructions. When the computer program product runs on a communications apparatus, the communications apparatus is enabled to perform the methods shown in FIG. 4 to FIG. 6.

An embodiment of this application provides a wireless communications apparatus. The wireless communications apparatus stores instructions. When the wireless communications apparatus runs on the communications apparatuses shown in FIG. 3, FIG. 7, and FIG. 8, the communications apparatuses are enabled to perform the communications methods shown in FIG. 4 to FIG. 6. The wireless communications apparatus may be a chip.

An embodiment of this application provides a communications system. The communications system includes a terminal and an access network device. For example, the terminal may be the communications apparatus shown in FIG. 3, FIG. 7, or FIG. 8, and the access network device may be the communications apparatus shown in FIG. 3, FIG. 7, or FIG. 8.

A transmitting node determines a first message, where a first field in the first message is set to be null, and the first field is used to indicate a time-frequency resource that carries hybrid automatic repeat request HARQ information. The transmitting node sends the first message to a receiving node, where the first message is used to indicate the receiving node to delay feeding back HARQ information corresponding to a first transport block TB, or the first message is used to indicate the receiving node to give up feeding back the HARQ information corresponding to the first TB; and the first TB is a transport block scheduled by the first message.

The receiving node receives the first message from the transmitting node, and gives up feeding back the HARQ information corresponding to the first TB, or delays feeding back the HARQ information corresponding to the first TB.

According to the foregoing description of the implementations, a person skilled in the art may clearly understand that, for the purpose of convenient and brief description, only division into the foregoing function modules is used as an example for description. In actual application, the foregoing functions may be allocated to different function modules and implemented based on a requirement. To be specific, an inner structure of a database access apparatus is divided into different function modules to implement all or some of the functions described above.

The processor in this embodiment of this application may include but is not limited to at least one of the following computing devices that run software: a central processing unit (CPU), a microprocessor, a digital signal processor (DSP), a microcontroller unit (MCU), an artificial intelligence processor, or the like. Each computing device may include one or more cores configured to perform an operation or processing by executing software instructions. The processor may be an independent semiconductor chip, or may be integrated with another circuit to form a semiconductor chip. For example, the processor and another circuit (for example, an encoding/decoding circuit, a hardware acceleration circuit, or various buses and interface circuits) may form a SoC. In some embodiments, the processor may be integrated into an ASIC as a built-in processor of the ASIC, and the ASIC integrated with the processor may be independently packaged or may be packaged with another circuit. In addition to the core configured to perform an operation or processing by executing software instructions, the processor may include a necessary hardware accelerator, for example, a field programmable gate array (FPGA), a PLD (programmable logic device), or a logic circuit that implements a dedicated logic operation.

The memory in the embodiments of this application may include at least one of the following types: a read-only memory (ROM) or another type of static storage device that can store static information and instructions, or a random access memory (RAM) or another type of dynamic storage device that can store information and instructions, or may be an electrically erasable programmable read-only memory (EEPROM). In some scenarios, the memory may alternatively be a compact disc read-only memory (CD-ROM) or another compact disc storage medium, an optical disc storage medium (including a compact disc, a laser disc, an optical disc, a digital versatile disc, a Blu-ray disc, and the like), a magnetic disk storage medium or another magnetic storage device, or any other medium that can be configured to carry or store expected program code in a form of instructions or a data structure and that can be accessed by a computer. However, the memory is not limited thereto.

In this application, “at least one” refers to one or more. “A plurality of” refers to two or more than two. The term “and/or” describes an association relationship between associated objects, and indicates that three relationships may exist. For example, A and/or B may indicate the following cases: A exists alone, both A and B exist, and B exists alone, where A and B may be singular or plural. The character “/” generally indicates an “or” relationship between the associated objects. At least one of the following or a similar expression thereof indicates any combination of the following, and includes any combination of one or more of the following. For example, at least one of a, b, or c may indicate: a, b, c, a and b, a and c, b and c, or a, b, and c, where a, b, and c may be singular or plural. In some embodiments, for convenience of clear description in the embodiments of this application, terms such as “first”, “second”, and the like are used to distinguish between same objects or similar objects whose functions and purposes are basically the same. A person skilled in the art may understand that the terms such as “first” and “second” do not limit a quantity or an execution sequence, and the terms such as “first” and “second” do not indicate a definite difference.

According to the foregoing description of the implementations, a person skilled in the art may clearly understand that, for the purpose of convenient and brief description, only division into the foregoing function modules is used as an example for description. In actual application, the foregoing functions may be allocated to different function modules and implemented based on a requirement. To be specific, an inner structure of a database access apparatus is divided into different function modules to implement all or some of the functions described above.

In the several embodiments provided in this application, it should be understood that the disclosed database access apparatus and method may be implemented in other manners. For example, the described database access apparatus embodiment is merely an example. For example, division into the modules or units is merely logical function division and may be other division in an actual implementation. For example, a plurality of units or components may be combined or integrated into another apparatus, or some features may be ignored or not performed. In some embodiments, the displayed or discussed mutual couplings or direct couplings or communications connections may be implemented through some interfaces. The indirect couplings or communications connections between the database access apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of the embodiments.

In some embodiments, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software function unit and sold or used as an independent product, the integrated unit may be stored in a readable storage medium. Based on such an understanding, the technical solutions of this application essentially, or the part contributing to the prior art, or all or some of the technical solutions may be implemented in the form of a software product. The software product is stored in a storage medium and includes several instructions for instructing a device (which may be a single-chip microcomputer, a chip, or the like) or a processor to perform all or some of the operations of the methods described in the embodiments of this application. The foregoing storage medium includes: any medium that can store program code, such as a flash memory, a removable hard disk, a read-only memory, a random access memory, a magnetic disk, or a compact disc.

The foregoing description is merely a specific implementation of this application, but is not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A method for indicating feedback information, comprising:
determining, by a transmitting node, a first message having a first field set to be null, wherein the first field is used to indicate a time-frequency resource that carries hybrid automatic repeat request (HARQ) information; and
sending, by the transmitting node, the first message to a receiving node, wherein the first message is used to indicate the receiving node to delay feeding back HARQ information corresponding to a first transport block (TB), or the first message is used to indicate the receiving node to give up feeding back the HARQ information corresponding to the first TB.

2. The method according to claim 1, wherein
the first message further comprises a second field, wherein when the second field includes a first value, the second field is used to indicate the receiving node to delay feeding back the HARQ information corresponding to the first TB; or when the second field includes a second value, the second field is used to indicate the receiving node to give up feeding back the HARQ information corresponding to the first TB.

3. The method according to claim 1, wherein the first message further comprises a third field that is used to indicate to delay feeding back a plurality of pieces of HARQ information having the HARQ information corresponding to the first TB.

4. The method according to claim 1, further comprising:
sending, by the transmitting node, a second message to the receiving node, wherein the second message comprises a fourth field that is used to indicate a feedback resource, wherein the feedback resource is used to carry the HARQ information corresponding to the first TB and HARQ information corresponding to a second TB scheduled by the second message.

5. The method according to claim 1, further comprising:
determining, by the transmitting node based on one or more of a congestion control status of a feedback resource, a quality of service (QoS) requirement, a priority of the first TB, or a feedback feature of the first TB, to set the first field to be null, wherein the feedback feature of the first TB indicates that the first TB is fed back based on a transport block granularity or that the first TB is fed back based on a code block group (CBG) granularity.

6. The method according to claim 1, wherein first TB is a transport block scheduled by the first message.

7. A communications apparatus, comprising:
a processor configured to determine a first message having a first field set to be null, wherein the first field is used to indicate a time-frequency resource that carries hybrid automatic repeat request (HARQ) information; and
a transceiver, configured to send the first message to a receiving node, wherein the first message is used to indicate the receiving node to delay feeding back HARQ information corresponding to a first transport block (TB), or the first message is used to indicate the receiving node to give up feeding back the HARQ information corresponding to the first TB.

8. The communications apparatus according to claim 7, wherein
the first message further comprises a second field, wherein when the second field includes a first value, the second field is used to indicate the receiving node to delay feeding back the HARQ information corresponding to the first TB; or when the second field includes a second value, the second field is used to indicate the receiving node to give up feeding back the HARQ information corresponding to the first TB.

9. The communications apparatus according to claim 7, wherein the first message further comprises a third field that is used to indicate to delay feeding back a plurality of pieces of HARQ information having the HARQ information corresponding to the first TB.

10. The communications apparatus according to claim 7, wherein the transceiver is further configured to send a second message to the receiving node, wherein the second message comprises a fourth field that is used to indicate a feedback resource, and the feedback resource is used to carry the HARQ information corresponding to the first TB and HARQ information corresponding to a second TB; and the second TB is scheduled by the second message.

11. The apparatus according to claim 7, wherein the processor is configured to:
determine, based on one or more of a congestion control status of a feedback resource, a quality of service (QoS) requirement, a priority of the first TB, or a feedback feature of the first TB, to set the first field to be null, wherein the feedback feature of the first TB comprises that the first TB is fed back based on a transport block granularity or that the first TB is fed back based on a code block group (CBG) granularity.

12. The apparatus according to claim 7, wherein first TB is a transport block scheduled by the first message.

13. A non-transitory computer-readable medium having instructions stored therein, which when executed by a processor, cause the processor to perform operations of indicating feedback information, the operations comprising:
determining a first message having a first field set to be null, wherein the first field is used to indicate a time-frequency resource that carries hybrid automatic repeat request (HARQ) information; and
sending the first message to a receiving node, wherein the first message is used to indicate the receiving node to delay feeding back HARQ information corresponding to a first transport block (TB), or the first message is used to indicate the receiving node to give up feeding back the HARQ information corresponding to the first TB.

14. The computer-readable medium according to claim 13, wherein the first message further comprises a second field, wherein when the second field includes a first value, the second field is used to indicate the receiving node to delay feeding back the HARQ information corresponding to the first TB; or when the second field includes a second value, the second field is used to indicate the receiving node to give up feeding back the HARQ information corresponding to the first TB.

15. The computer-readable medium according to claim 13, wherein the first message further comprises a third field that is used to indicate to delay feeding back a plurality of pieces of HARQ information having the HARQ information corresponding to the first TB.

16. The computer-readable medium according to claim 13, wherein the operations further comprise:
sending a second message to the receiving node, wherein the second message comprises a fourth field that is used to indicate a feedback resource, wherein the feedback resource is used to carry the HARQ information corresponding to the first TB and HARQ information corresponding to a second TB scheduled by the second message.

17. The computer-readable medium according to claim 13, wherein the operations further comprise:
determining, based on one or more of a congestion control status of a feedback resource, a quality of service (QoS) requirement, a priority of the first TB, or a feedback feature of the first TB, to set the first field to be null, wherein the feedback feature of the first TB indicates that the first TB is fed back based on a transport block granularity or that the first TB is fed back based on a code block group (CBG) granularity.

18. The computer-readable medium according to claim 13, wherein first TB is a transport block scheduled by the first message.
